(19) United States
(12) Patent Application Publication
(10) Pub. No.: US 2010/0307813 A1
(43) Pub. Date: Dec. 9, 2010

(54) CARRIER TUBE FOR CEILING ELEMENTS

(75) Inventors: Bernhard Randerath, Assel (DE); Andreas Sachse, Kakenstorf (DE); Hans Damm, Iffezheim (DE)

Correspondence Address: LUCAS & MERCANTI, LLP, 475 PARK AVENUE SOUTH, 15TH FLOOR, NEW YORK, NY, 10016, US

(73) Assignees: AIRBUS OPERATIONS GMBH, Hamburg (DE); ELMAKO GMBH & CO. KG, Iffezheim (DE)

(21) Appl. No.: 12/739,774

(22) PCT Filed: Oct. 22, 2008
(86) PCT No.: PCT/EP2008/008930

§ 371 Date: Aug. 26, 2010

(30) Foreign Application Priority Data
Oct. 25, 2007 (DE) 10 2007 051 410.9

(51) Int. Cl. H02G 3/30

(52) U.S. Cl. 174/491

(57) ABSTRACT

A carrier tube for ceiling elements, particularly for aircraft cabins, including electrical lines running inside the carrier tube. In order to obtain high flexibility regarding the position from where current is to be conducted from the electrical lines to components in the ceiling elements, the carrier tube proposes for the lines to be designed as busbars and thus to mount them toward the inside of the carrier tube in a non-insulated way at the inside of the wall of the carrier tube. Furthermore, the carrier tube provides for the busbar system to be combined with a corresponding collector including contacts that correspond to the busbar.

The invention relates to a carrier tube for ceiling elements, in particular for aircraft cabins, with electrical lines running inside the carrier tube.

In aircraft construction, it is known to accommodate the most diverse possible seating arrangements in the cabin of a commercial aircraft. These seating arrangements differ from one another, depending on class (first class, business class or economy class) and/or depending on the aviation company, in the number of seats installed per row and in the different row spacing.

A particular problem which arises in this case is that the cabins are converted for different intended uses, for example in the case of an increased demand for first class seats or business class seats.

Above each seat are located panels or ceiling elements which contain elements, such as calling buttons, belt-fastening signs which light up, lamps, etc., and also flaps for oxygen masks for emergencies. During conversion, these elements have to be adapted to the changed spacings according to the seats.

To connect said electrical elements, it is in this case known to connect them by means of cables, corresponding cables and plug connectors being provided in each case for a maximum-occupation seating arrangement. If the aircraft cabin has a seating arrangement with fewer seats, only fewer elements are connected and part of the existing cabling remains unused.

Cabling in this case has a disadvantage, on the one hand, that it constitutes considerable weight, and, in particular, the fact also has to be taken into account that this weight reduces both the payload of the aircraft and, as ballast, also adversely influences the fuel consumption.

Furthermore, there is the problem that the resulting cable harnesses are complicated to install, copious construction space also having to be provided for this purpose.

It is known, then, to fasten the corresponding ceiling elements to carrying tubes provided for this purpose, these usually being produced as aluminum extruded profiles. Both circular and polygonal cross-sectional shapes are in this case known. Sometimes, the cables referred to, in order to save space for them and make it easier to install them, are routed within these carrying tubes. The plugs normally present at the ends of the cables are, however, still located outside these carrying tubes. They may therefore correspondingly obstruct the handling of the individual ceiling elements when these are being mounted and demounted.

The object of the present invention, therefore, is to develop further a carrier tube for ceiling elements, in particular for aircraft cabins, with electrical lines running inside the carrier tube, to the effect that construction becomes easier. At the same time, the connection of lines running inside the carrier tube to electrical components present in the ceiling elements is to be simplified.

This object is achieved in that the lines provided, as busbars, are attached, uninsulated toward the interior of the carrier tube, to the wall of the carrier tube on the inside.

The invention has the advantage that the lines provided, as busbars, no longer have to be insulated individually. Since they are attached to the wall of the carrier tube, they can readily be held so as to be spaced apart from one another, and there is no risk of electrical short circuits on account of the missing insulation. Furthermore, the uninsulated state of the lines or busbars means that they can be contacted everywhere by means of a corresponding current collector. There is therefore no need, in the case of a plurality of possible positions in which corresponding current collection is to take place, to keep in reserve in each case separate lines with plugs provided in the specific positions. Instead, a suitable contact merely has to be provided, which is to be introduced into the carrier tube in each case at the desired location and is to be brought into contact with the busbars provided there. Thus, a plurality of lines can be saved, which would be used merely alternatively or else selectively, depending on requirements.

In a preferred exemplary embodiment, the busbars run in longitudinal grooves of the carrier tube wall. As a result, the busbars can be fixed in their position well and can be tapped in an operationally reliable way by means of a suitable plug.

In a further preferred embodiment, the busbars are attached to a carrier made from insulating material which is introduced into the carrier tube parallel to the longitudinal axis of the latter.

Such a design has the advantage that, on the one hand, no short circuit can occur between the busbars and the carrier tube. On the other hand, the busbars can preferably also be attached to the carrier outside the carrier tube. This makes manufacture easier, since a plurality of busbars can be fastened to one carrier and then only one carrier has to be inserted into the carrier tube.

It has in this case proved to be advantageous that the carrier itself has an essentially sheet-like configuration and, for it, a corresponding receptacle is provided in the carrier tube, into which receptacle the carrier can be inserted, at the same time experiencing elastic deformation.

This design is likewise to be considered highly advantageous for manufacturing reasons.

For easier assembly, the carrier tube may have a longitudinal slot. A junction plug or current collector matching with the busbars can also be easily led through this into the interior of the tube.

Preferably, corresponding fixing rails are then provided parallel to this longitudinal slot, by means of which fixing rails the current collector can then be fixed correspondingly.

Although it is within the scope of the invention to produce the carrier tube provided from aluminum, for reasons of a saving of weight it is preferable to produce the carrier tube from fiber-reinforced plastic.

Further advantages and features of the invention may be gathered from the following description of exemplary embodiments. In the drawing:

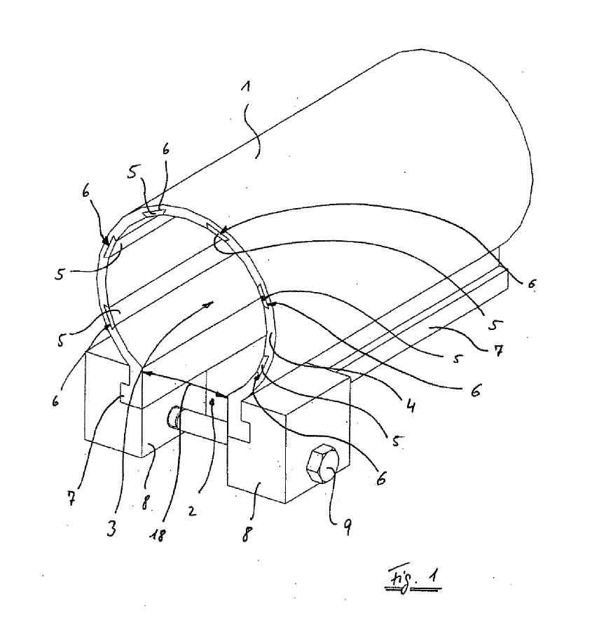

FIG. 1 shows a carrier tube with busbars integrated into the wall;

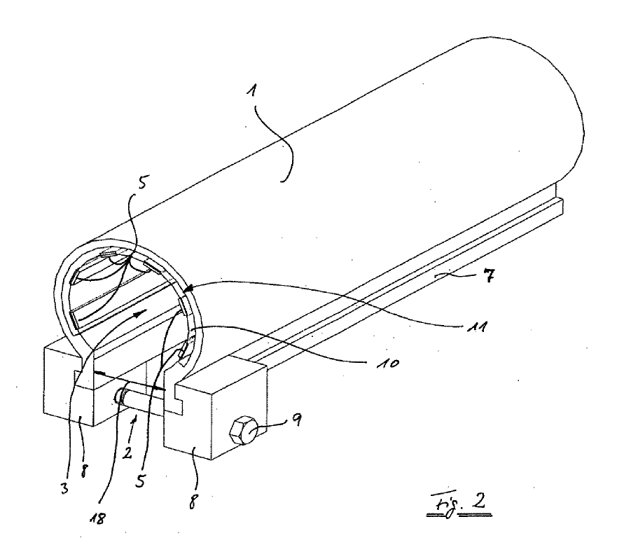

FIG. 2 shows a carrier tube with a carrier insert holding the busbars;

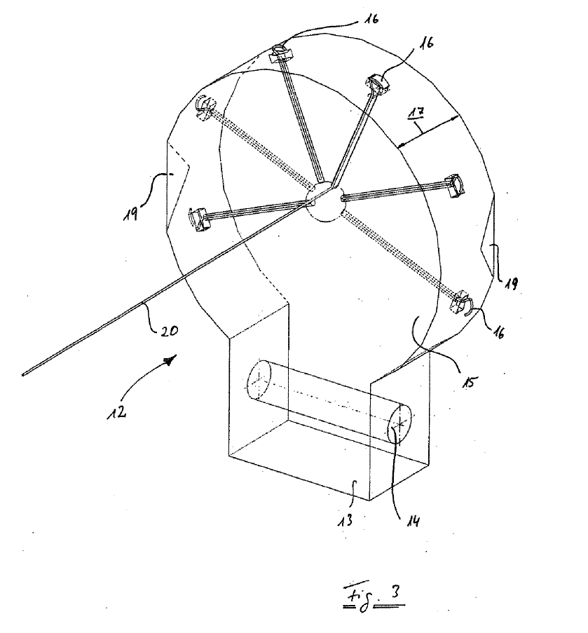

FIG. 3 shows a basic diagram of a current collector.

A perspective illustration of a carrier tube 1, to which, for example, ceiling elements are fastened in an aircraft cabin, can be seen in FIG. 1. The carrier tube illustrated here has an essentially Ω-shaped cross section with an essentially circular portion and with a downwardly opening slot region 2, by means of which the interior 3 of the carrier tube opens outward. A plurality of busbars 5 are located, distributed over the circumference in the wall 4, in the circular portion of the carrier tube 1, running parallel to one another and to the longitudinal axis of the carrier tube 1 and are uninsulated toward the interior 3 of the carrier tube 1. These busbar surfaces facing the interior 3 are gold-plated, while the busbar itself is made, in particular, from copper.

It is also basically possible, however, to manufacture the busbar from another highly electrically conductive material, and gold-plating is also not necessary in so far as an oxidation of the metallic surface of the busbar 5 is prevented in another way.

In the example illustrated here, the wall 4 of the carrier tube 1 consists, in particular, of fiber-reinforced plastic. It is also possible, however, to provide here a metal, such as, for example, aluminum, and to give this an electrically nonconductive coating, so that electrical short circuits cannot occur between the individual busbars 5.

Moreover, it can be seen in FIG. 1 that the busbars 5 are inserted in grooves 6 which are formed into the wall 4 of the carrier tube 1. The grooves 6 in this case have undercuts, so that the busbars 5 are held positively in these grooves.

In the example illustrated here, the edges lying parallel to the slot region 2 of the carrier tube are provided with fixing rails 7 running parallel to said longitudinal slot. Any desired element, such as, for example, a snap fastening or a hinge for a ceiling element to be fastened to the carrier tube 1, may be fastened on these fixing rails via clamping blocks 8.

In each case two clamping blocks 8 are assigned to one another and are connected by means of a clamping screw 9. Instead of a clamping screw, other connecting elements may also be used. For example, the use of tension springs or the like is also possible.

A comparable design to that of FIG. 1 is illustrated in FIG. 2. A carrier tube 1 with busbars 5 arranged in its interior 3 can be seen once again. In the example illustrated in FIG. 2, however, these busbars 5 are attached on a carrier 10. This consists of an insulating material, such as is employed, for example, as a deformable circuit board.

This carrier has essentially a sheet-like configuration and is inserted into a recess 11 of the carrier tube 1, said recess running parallel to the longitudinal axis of the carrier tube 1. In this case, the carrier 10, on account of its inherent tension resulting from its deformation which takes place during insertion, comes to bear against the wall of this recess 11 and is thus held essentially nonpositively within the carrier tube 1.

There is in this case the possibility of also gluing the carrier 10 inside this recess 11 of the carrier tube 1.

Moreover, the carrier tube illustrated in FIG. 2 is also provided with corresponding fixing rails 7 and with clamping blocks 8 which match these and which are again connected to one another via a clamping screw 9.

The busbars used in the carrier tube according to FIG. 2 have a cross-sectional area of about 0.5 mm², so that a current sufficient for customary requirements can be conducted via these.

In order to extract this current from the carrier tube, a current collector 12, such as is illustrated in FIG. 3, is used. This current collector has an essentially circular upper portion 15 and a box-shaped portion 13 adjoining the latter. The box-shaped portion 13 is provided with a transverse bore 14. This is provided in order to match with the shank of the clamping screw 9 when the current collector 12 is inserted into the interior 3 of the carrier tube 1. The current collector 12 has, over the circumference of the circular portion 15, a plurality of resilient contacts 16 which correspond in their position to the position of the busbars 5 on the wall 4 of the carrier tube 1. Junction lines 20 run from these contacts 16 to elements, not illustrated here, such as belt-fastening signs, reading lamps, bell buttons or the like.

To attach the current collector 12 inside the carrier tube 1, the current collector 12 is led through the slot region 2. For this purpose, its width 17 is somewhat smaller than the width 18 of the slot region 2.

The current collector 12 is then rotated through about 90° until the transverse bore 14 lies parallel to the clamping screw 9. For rotating the current collector, the latter is provided with corresponding roundings 19 at the edges relevant for this purpose. A clamping screw 9 is subsequently led through a clamping block 8 and the transverse bore 14 in the box-shaped portion 13 of the current collector 12 and then into a clamping block 8, so that the current collector 12 is fixed in this position. By clamping screw 9 being tightened, the axial position of the current collector 12 inside the carrier tube 1 is also secured.

In this position, an electrical connection of the line 20 to the busbars 5 via the resilient contacts 16 is then afforded.

Since the current collectors 12 can be fastened in any desired axial position within the carrier tube 1, the device described offers the possibility of positioning current collectors at exactly the locations where corresponding consumers, such as lamps, light-up signs or operating elements, such as buttons, etc., are present in the immediate vicinity. There is thus the possibility of providing position-exact connecting elements for ceiling elements of the most diverse possible types, which match with aircraft seats standing under them and having the most diverse possible seat spacing.

It may once again be mentioned at this juncture that the carrier tube itself may be provided, in particular, for carrying said ceiling elements. These can in this case be fastened to the carrier tube 1 by means of connecting elements carried via clamping blocks and clamping screws.

The carrier tube thus functions, on the one hand, as a carrier for the ceiling elements and, on the other hand, as routing of electrical lines to structural elements provided in these ceiling elements.

It is obvious to a person skilled in the art that the number of busbars provided within the carrier tube is to be adapted to corresponding requirements. Even though only six busbars are illustrated in the illustrations described above, a considerably larger or smaller number is also possible.

1. A carrier tube for ceiling elements, in particular for aircraft cabins, with electrical lines running inside the carrier tube, wherein the lines, as busbars, are attached, uninsulated toward the interior of the carrier tube, to the wall of the carrier tube on the inside.

2. The carrier tube as claimed in claim 1, wherein the busbars run in longitudinal grooves of the carrier tube wall.

3. The carrier tube as claimed in claim 1, wherein the busbars are attached to a carrier made from electrically insulating material which is introduced into the carrier tube parallel to the longitudinal axis of the latter.

4. The carrier tube as claimed in claim 3, wherein the carrier has an essentially sheet-like configuration.

5. The carrier tube as claimed in claim 4, wherein the carrier can be inserted into a recess of the carrier tube, at the same time experiencing elastic deformation.

6. The carrier tube as claimed in claim 1, wherein the carrier tube is made from fiber-reinforced plastic.

7. The carrier tube as claimed in claim 1, wherein it has a longitudinal slot.

8. The carrier tube as claimed in claim 8, wherein it has fixing rails parallel to the longitudinal slot.
